(19) United States
(12) Patent Application Publication
(10) Pub. No.: US 2026/0169209 A1
(43) Pub. Date: Jun. 18, 2026

(54) OPTICAL FILTER AND IMAGING DEVICE

(71) Applicant: AGC INC., Tokyo (JP)

(72) Inventors: Takashi NAGATA, Haibara-gun (JP); Takahiro SAKAGAMI, Haibara-gun (JP); Kanako OHGUCHI, Haibara-gun (JP); Kazuhiko SHIONO, Koriyama-shi (JP); Kiyokazu ENDO, Koriyama-shi (JP)

(73) Assignee: AGC INC., Tokyo (JP)

(21) Appl. No.: 19/532,048

(22) Filed: Feb. 6, 2026

Related U.S. Application Data
(63) Continuation of application No. PCT/JP2024/029107, filed on Aug. 15, 2024.

(30) Foreign Application Priority Data
Aug. 23, 2023 (JP) 2023-135099

(51) Int. Cl. G02B 5/20

(52) U.S. Cl. CPC G02B 5/208

(57) ABSTRACT

The invention provides an optical filter including a glass substrate, in which: on a first main surface of the glass substrate, a first barrier layer, a resin layer, and a first multilayer film are arranged in this order from the glass substrate; on a second main surface of the glass substrate, a second barrier layer and a second multilayer film are arranged in this order from the glass substrate; the glass substrate is a phosphate glass containing an infrared absorber; each of the first barrier layer and the second barrier layer independently contains, in an amount of 80 mol % or more, an oxide of at least one metal selected from the group consisting of titanium (Ti), niobium (Nb), tantalum (Ta), and hafnium (Hf); and each of the first multilayer film and the second multilayer film is independently composed of plural dielectric layers.

### CROSS-REFERENCE TO RELATED APPLICATIONS

This application is a continuation of International Application No. PCT/JP2024/029107, filed on Aug. 15, 2024, which claims priority from Japanese Patent Application No. 2023-135099, filed on Aug. 23, 2023. The entire disclosure of each of the above applications is incorporated herein by reference.

### TECHNICAL FIELD

The present invention relates to an optical filter and an imaging device.

### BACKGROUND ART

Imaging devices such as vehicle-mounted cameras and smartphone cameras are provided with solid-state image sensors (e.g., CCDs and CMOSs). However, solid-state image sensors exhibit higher sensitivity to infrared light than human visual perception. Therefore, in order to bring the images captured by the solid-state image sensors closer to human visual perception, optical filters are additionally installed in the image sensors.

### RELATED ART DOCUMENTS

### Patent Documents

Patent Document 1: WO 2014/030628
Patent Document 2: WO 2023/282187

### SUMMARY OF THE INVENTION

### Technical Problem

High-precision optical filters are required to have (1) high transmittance in the visible light region, (2) high light-blocking performance in the infrared region, and (3) optical characteristics that do not vary with the incidence angle of light.

In this respect, Patent Document 1 discloses an optical filter having a CuO-containing fluorophosphate glass substrate. The CuO-containing fluorophosphate glass substrate has a function of absorbing infrared rays to a certain extent. It is disclosed that, therefore, an optical filter having the above-described effects of (1) to (3) can be provided by combining the CuO-containing fluorophosphate glass substrate with a dye-containing layer and an infrared reflective film.

However, according to the inventors of the present application, it has been recognized that the effects of (2) and (3) are far from sufficient even in the optical filter disclosed in Patent Document 1.

Meanwhile, Patent Document 2 discloses an optical filter in which a phosphate glass is used instead of a fluorophosphate glass as a glass substrate. A CuO-containing phosphate glass has a higher infrared absorption function than a CuO-containing fluorophosphate glass. It is disclosed that, therefore, a filter having a significantly higher light-blocking performance in the infrared region can be obtained by using such a phosphate glass substrate.

Nevertheless, based on the experience of the inventors of the present application, phosphate glass has a problem of being likely to elute upon coming into contact with water. Accordingly, in an optical filter in which a phosphate glass is applied as a glass substrate, the glass substrate deteriorates with time, potentially causing a problem of reduction in the filter properties.

The invention was made in view of the above-described background, and an object of the invention is to provide an optical filter which has significantly higher light-blocking performance in the infrared region, and in which the problem with water resistance is significantly improved.

### Solution to Problem

The invention provides an optical filter including a glass substrate, in which
the glass substrate has a first main surface and a second main surface, which are opposite to each other,
on the first main surface of the glass substrate, a first barrier layer, a resin layer, and a first multilayer film are arranged in this order from the glass substrate,
on the second main surface of the glass substrate, a second barrier layer and a second multilayer film are arranged in this order from the glass substrate,
the glass substrate is a phosphate glass containing an infrared absorber,
each of the first barrier layer and the second barrier layer independently contains, in an amount of 80 mol % or more, an oxide of at least one metal selected from the group consisting of titanium (Ti), niobium (Nb), tantalum (Ta), and hafnium (Hf) in a ratio of 80 mol % or more,
the resin layer contains a near-infrared absorbing dye having a maximum absorption wavelength in a range of 700 nm to 800 nm, and
each of the first multilayer film and the second multilayer film is independently composed of plural dielectric layers.

### Advantageous Effects of Invention

The invention can provide an optical filter which has significantly higher light-blocking performance in the infrared region, and which has significantly improved water resistance.

### BRIEF DESCRIPTION OF DRAWINGS

FIG. 1 is a cross-sectional view that schematically illustrates an example of the configuration of the optical filter according to one embodiment of the invention.

FIG. 2 is a cross-sectional view that schematically illustrates an example of the configuration of the optical filter according to another embodiment of the invention.

FIG. 3 is a flow chart that schematically illustrates one example of the method of producing an optical filter according to one embodiment of the invention.

FIG. 4 is a graph showing one example of optical characteristic of the glass substrate included in the optical filter according to one embodiment of the invention.

FIG. 5 is a graph showing one example of optical characteristic (transmittance) of the optical filter according to one embodiment of the invention.

FIG. 6 is a graph showing one example of optical characteristic (reflectance measured on the side of the second multilayer film) of the optical filter according to one embodiment of the invention.

FIG. 7 is a graph showing one example of optical characteristic (reflectance measured on the side of the first multilayer film) of the optical filter according to one embodiment of the invention.

### DESCRIPTION OF EMBODIMENTS

One embodiment of the invention will now be described with reference to the drawings.

As described above, the optical filter disclosed in Patent Document 1 has a problem in that the above-described effects of (2) and (3) are still far from sufficient. In addition, an optical filter in which a phosphate glass is applied as a substrate instead of a fluorophosphate glass may have a problem in terms of environmental durability due to its low resistance to water.

Under such circumstances, the inventors of the present application pursued intensive research and development, and discovered an optical filter which has significantly higher light-blocking performance in the infrared region, and which has significantly improved. water resistance.

In other words, one embodiment of the invention provides an optical filter including a glass substrate, in which
the glass substrate has a first main surface and a second main surface, which are opposite to each other,
on the first main surface of the glass substrate, a first barrier layer, a resin layer, and a first multilayer film are arranged in this order from the glass substrate,
on the second main surface of the glass substrate, a second barrier layer and a second multilayer film are arranged in this order from the glass substrate,
the glass substrate is a phosphate glass containing an infrared absorber,
each of the first barrier layer and the second barrier layer independently contains an oxide of at least one metal selected from the group consisting of titanium (Ti), niobium (Nb), tantalum (Ta), and hafnium (Hf),
the resin layer contains a near-infrared absorbing dye having a maximum absorption wavelength in a range of 700 nm to 800 nm, and
each of the first multilayer film and the second multilayer film is independently composed of plural dielectric layers.

In the optical filter according to one embodiment of the invention, a phosphate glass containing an infrared absorber is used as the glass substrate.

Therefore, in the optical filter according to one embodiment of the invention, superior infrared absorption characteristics can be obtained as compared to a conventional optical filter in which a phosphate glass substrate is used.

Further, in the optical filter according to one embodiment of the invention, the first barrier layer and the second barrier layer are arranged on the first main surface and the second main surface of the phosphate glass, respectively. Each of the first barrier layer and the second barrier layer independently contains, in an amount of 80 mol % or more, an oxide of at least one metal selected from the group consisting of titanium (Ti), niobium (Nb), tantalum (Ta), and hafnium (Hf).

In the optical filter according to one embodiment of the invention, the first barrier layer and second barrier layer, which have such protective performance against water, are arranged on the respective main surfaces of the glass substrate, whereby the environmental durability of the glass substrate against the external environment is improved. Accordingly, in the optical filter according to one embodiment of the invention, although a phosphate glass is used as the glass substrate, the problem of elution of the glass substrate is significantly inhibited, allowing the optical filter to exert stable properties over an extended period.

In one embodiment of the invention, the first main surface of the glass substrate is covered with the first barrier layer, and the second main surface of the glass substrate is covered with the second barrier layer. On the other hand, the end surfaces of the glass substrate does not necessarily need to be provided with the oxide.

This is because the proportion of the end surfaces with respect to a total surface area of the glass substrate is sufficiently small, and the problem of glass elution can be suppressed as long as the main surfaces, which occupy most of the surface area of the glass substrate, are covered with the above-described barrier layers.

### (Optical Filter According to One Embodiment of Invention)

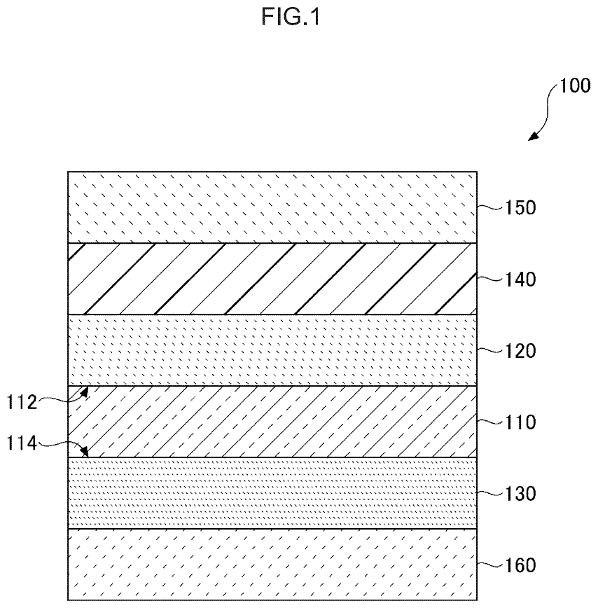

The optical filter according to one embodiment of the invention will now be described in more detail with reference to FIG. 1.

FIG. 1 schematically illustrates a cross-section of the configuration of the optical filter according to one embodiment of the invention.

As illustrated in FIG. 1, an optical filter 100 according to one embodiment of the invention (hereinafter, referred to as “first optical filter”) includes a glass substrate 110 having a first main surface 112 and a second main surface 114, which are opposite to each other.

The glass substrate 110 is composed of a phosphate glass containing an infrared absorber. In the present specification, a “phosphate glass” means a glass that contains 40% by mass or more of P₂O₅ in terms of oxide and is substantially free of a fluorine atom component. The term “substantially free of” used herein means that, when the content of component elements other than F in the glass is taken as 100% by mass and the content of F in the glass is expressed as an external basis, the content of F is less than 3% by mass in external basis.

On the first main surface 112 side of the glass substrate 110, a first barrier layer 120, a resin layer 140, and a first multilayer film 150 are arranged in this order from the glass substrate 110. Further, on the second main surface 114 side of the glass substrate 110, a second barrier layer 130 and a second multilayer film 160 are arranged in this order from the glass substrate 110.

The first multilayer film 150 and the second multilayer film 160 are each composed of plural dielectric layers. Further, the resin layer 140 contains a near-infrared absorbing dye having a maximum absorption wavelength in a range of 700 nm to 800 nm.

Each of the first barrier layer 120 and the second barrier layer 130 independently contains an oxide of at least one metal selected from the group consisting of titanium (Ti), niobium (Nb), tantalum (Ta), and hafnium (Hf).

As described above, the glass substrate 110 composed of a phosphate glass tends to relatively easily elute upon coming into contact with water in the environment.

However, in the first optical filter 100, the first main surface 112 and the second main surface 114 of the glass substrate 110 are protected by the first barrier layer 120 and the second barrier layer 130, which contain the above-described material, respectively.

Therefore, the first optical filter 100 can significantly reduce the problem of elution of the glass substrate 110 caused by reaction with water of the external environment.

In addition, in the first optical filter 100, a phosphate glass having a high infrared absorption function is used as the glass substrate 110 instead of a fluorophosphate glass. Therefore, the first optical filter 100 can exhibit significantly high light-blocking performance in the infrared region.

### (Regarding Components Included in Optical Filter According to One Embodiment of Invention)

Next, each component constituting the optical filter according to one embodiment of the invention will be described in more detail. It is noted here that, for the sake of clarity, the components will be described taking the first optical filter 100 illustrated in FIG. 1 as an example. Accordingly, the reference numerals in FIG. 1 are used for describing the respective components.

### (Glass Substrate 110)

The glass substrate 110 used in the optical filter according to one embodiment of the invention will now be described. In the description of the glass substrate, unless otherwise specified, the content of each component and a total content of components are expressed as values of oxide-based mass percentage.

The glass substrate 110 is composed of a phosphate glass containing an infrared absorber. From the standpoint of obtaining excellent infrared absorption performance, the infrared absorber is preferably CuO or Fe₂O₃; however, other components may be used as well.

For example, the glass substrate 110 may contain the following components in terms of oxide-based mass percentage:
from 40% to 75% of P₂O₅;
from 10% to 30% of Al₂O₃;
from 2% to 30% of CuO;
from 0.1% to 30% of R(1)₂O, wherein R(1) represents at least one component selected from the group consisting of Li, Na, K, Rb, and Cs; and
from 0 to 30% of R(2)O, wherein R(2) represents at least one component selected from the group consisting of Ca, Mg, Ba, Sr, and Zn, and
the glass substrate 110 is substantially free of F.

P₂O₅ is a main component forming the glass, and is a component for enhancing the near-infrared cut-off property. When the content of P₂O₅ is 40% or more, the effect thereof is sufficiently obtained, while when the content of P₂O₅ is 75% or less, problems such as destabilization of the glass and deterioration of the weather resistance are unlikely to occur. Therefore, the content of P₂O₅ is preferably from 40 to 75%, more preferably from 45 to 73%, still more preferably from 47 to 71%, yet still more preferably from 50 to 69%, most preferably from 55 to 67%.

Al₂O₃ is a main component forming the glass, and is a component for, for example, improving the strength of the glass. When the content of Al₂O₃ is 10% or more, the effect thereof is sufficiently obtained, while when the content of Al₂O₃ is 30% or less, problems such as destabilization of the glass and deterioration of the near-infrared cut-off property are unlikely to occur. Therefore, the content of Al₂O₃ is preferably from 10 to 30%, more preferably from 11 to 29%, still more preferably from 12 to 28%, yet still more preferably from 13 to 27%, most preferably from 14 to 26%. When the content of Al₂O₃ is 14% or more, the weather resistance of the glass can be enhanced.

R₂O (wherein, R₂O is one or more components selected from Li₂O, Na₂O, K₂O, Rb₂O, and Cs₂O) is a component for, for example, lowering the melting temperature of the glass, lowering the liquid phase temperature of the glass, and stabilizing the glass. When the total amount of R₂O (ΣR₂O) is 0.1% or more, the effect thereof is sufficiently obtained, while when the total amount of R₂O (ΣR₂O) is 30% or less, destabilization of the glass is unlikely to occur, which is preferable. Therefore, the total amount of R₂O (ΣR₂O) is preferably from 0.1 to 30%, more preferably from 0.4 to 27%, still more preferably from 0.7 to 24%, yet still more preferably from 1.0 to 21%, most preferably from 1.3 to 18%.

Li₂O is a component for, for example, lowering the melting temperature of the glass, lowering the liquid phase temperature of the glass, and stabilizing the glass. The content of Li₂O is preferably from 0 to 20%. When the content of Li₂O is 20% or less, problems such as destabilization of the glass and deterioration of the near-infrared cut-off property are unlikely to occur, which is preferable. The content of Li₂O is more preferably from 0 to 15%, still more preferably from 0 to 10%, yet still more preferably from 0 to 5%, and most preferably, Li₂O is not substantially contained.

It is noted that the expression “(a specific component) is not substantially contained” used herein means that the component is not intentionally added, and does not exclude that the component is unavoidably incorporated from a raw material or the like to such an extent that does not affect the expected properties.

Na₂O is a component for, for example, lowering the melting temperature of the glass, lowering the liquid phase temperature of the glass, and stabilizing the glass. The content of Na₂O is preferably from 0 to 20%. When the content of Na₂O is 20% or less, destabilization of the glass is unlikely to occur, which is preferable. The content of Na₂O is more preferably from 0.5 to 17%, still more preferably from 1 to 14%, yet still more preferably from 1.5 to 11%.

K₂O is a component that has the effects of, for example, lowering the melting temperature of the glass and lowering the liquid phase temperature of the glass. The content of K₂O is preferably from 0 to 20%. When the content of K₂O is 20% or less, destabilization of the glass is unlikely to occur, which is preferable. The content of K₂O is more preferably from 1 to 18%, still more preferably from 2 to 15%, yet still more preferably from 3 to 13%.

Rb₂O is a component that has the effects of, for example, lowering the melting temperature of the glass and lowering the liquid phase temperature of the glass. The content of Rb₂O is preferably from 0 to 20%. When the content of Rb₂O is 20% or less, destabilization of the glass is unlikely to occur, which is preferable. The content of Rb₂O is more preferably from 0.5 to 18%, still more preferably from 1 to 16%, yet still more preferably from 2 to 14%.

Cs₂O is a component that has the effects of, for example, lowering the melting temperature of the glass and lowering the liquid phase temperature of the glass. The content of Cs₂O is preferably from 0 to 20%. When the content of Cs₂O is 20% or less, destabilization of the glass is unlikely to occur, which is preferable. The content of Cs₂O is more preferably from 0.5 to 18%, still more preferably from 1 to 16%, yet still more preferably from 2 to 14%.

When two or more kinds of the above-described alkali metal components represented by R₂O are added at the same time, a mixed alkali effect is generated in the glass, and the mobility of R⁺ ions is reduced. As a result, when the glass comes into contact with water, the hydration reaction caused by ion exchange between H⁺ ions in water molecules and the R⁺ ions in the glass is inhibited, and the weather resistance of the glass is improved. Accordingly, the glass of the present embodiment preferably contains two or more components selected from Li₂O, Na₂O, K₂O, Rb₂O, and Cs₂O. In this case, a total amount (ΣR₂O) of R₂O (wherein, R₂O is Li₂O, Na₂O, K₂O, Rb₂O, and Cs₂O) is preferably from 12 to 25%. When the total amount of R₂O is more than 12%, the effect thereof is sufficiently obtained, while when the total amount of R₂O is 25% or less, problems such as destabilization of the glass, deterioration of the near-infrared cut-off property, and reduction in strength of the glass are unlikely to occur, which is preferable. Therefore, ΣR₂O is preferably from 12 to 25%, more preferably from 13 to 24%, still more preferably from 14 to 25%, yet still more preferably from 15% to 26%, most preferably from 16 to 24%.

R′O (wherein, R′O is one or more components selected from CaO, MgO, BaO, SrO, and ZnO) is a component for, for example, lowering the melting temperature of the glass, lowering the liquid phase temperature of the glass, stabilizing the glass, and improving the strength of the glass. A total amount (ΣR′O) of R′O is preferably from 0 to 30%. When the total amount of R′O is 30% or less, problems such as destabilization of the glass, deterioration of the near-infrared cut-off property, reduction in the transmission of short-wavelength infrared rays, and reduction in strength of the glass are unlikely to occur, which is preferable. The total amount of R′O is more preferably from 0 to 25%, still more preferably from 0 to 20%, yet still more preferably from 0 to 15%, further preferably from 0 to 10%.

The glass of the present embodiment is preferably substantially free of a divalent cation other than Cu. The reasons for this are described below.

When the glass of the present embodiment contains CuO, light in the near-infrared region is cut off by light absorption of Cu²⁺ ions. This light absorption is caused by electronic transition between the d-orbitals of Cu²⁺ ions split by the electric field of O²⁻ ions. The splitting of the d-orbitals is facilitated when the symmetry of O²⁻ ions around Cu²⁺ ions decreases. For example, when cations exist around O²⁻ ions, the O²⁻ ions are attracted by the electric field of the cations, and the symmetry of the O²⁻ ions decreases. As a result, the splitting of d-orbitals is facilitated, and light absorption occurs due to electronic transition between the split d-orbitals, which weakens the light absorption capacity in the near-infrared region and strengthens the light absorption capacity in the short-wavelength infrared region. Since the electric field strength of cations increases with the valence of ions, addition of an oxide containing a divalent cation other than Cu in particular to the glass may cause deterioration of the near-infrared cut-off property and reduction in the transmission of short-wavelength infrared rays.

CaO is a component for, for example, lowering the melting temperature of the glass, lowering the liquid phase temperature of the glass, stabilizing the glass, and improving the strength of the glass. The content of CaO is preferably from 0 to 20%. When the content of CaO is 20% or less, problems such as destabilization of the glass, deterioration of the near-infrared cut-off property, and reduction in the transmission of short-wavelength infrared rays are unlikely to occur, which is preferable. The content of CaO is more preferably from 0 to 15%, still more preferably from 0 to 10%, yet still more preferably from 0 to 5%. Most preferably, CaO is not substantially contained.

MgO is a component for, for example, lowering the melting temperature of the glass, lowering the liquid phase temperature of the glass, stabilizing the glass, and improving the strength of the glass. The content of MgO is preferably from 0 to 20%. When the content of MgO is 20% or less, problems such as destabilization of the glass, deterioration of the near-infrared cut-off property, and reduction in the transmission of short-wavelength infrared rays are unlikely to occur, which is preferable. The content of MgO is more preferably from 0 to 15%, still more preferably from 0 to 10%, yet still more preferably from 0 to 5%. Most preferably, MgO is not substantially contained.

BaO is a component for, for example, lowering the melting temperature of the glass, lowering the liquid phase temperature of the glass, and stabilizing the glass. The content of BaO is preferably from 0 to 20%. When the content of BaO is 20% or less, problems such as destabilization of the glass, deterioration of the near-infrared cut-off property, and reduction in the transmission of short-wavelength infrared rays are unlikely to occur, which is preferable. The content of BaO is more preferably from 0 to 15%, still more preferably from 0 to 10%, yet still more preferably from 0 to 5%. The content of BaO may be 0.1% or more. Most preferably, BaO is not substantially contained.

SrO is a component for, for example, lowering the melting temperature of the glass, lowering the liquid phase temperature of the glass, and stabilizing the glass. The content of SrO is preferably from 0 to 20%. When the content of SrO is 20% or less, problems such as destabilization of the glass, deterioration of the near-infrared cut-off property, and reduction in the transmission of short-wavelength infrared rays are unlikely to occur, which is preferable. The content of SrO is more preferably from 0 to 15%, still more preferably from 0 to 10%. Most preferably, SrO is not substantially contained.

ZnO has the effects of, for example, lowering the melting temperature of the glass and lowering the liquid phase temperature of the glass. The content of ZnO is preferably from 0 to 20%. When the content of ZnO is 20% or less, problems such as deterioration of the solubility of the glass, deterioration of the near-infrared cut-off property, and reduction in the transmission of short-wavelength infrared rays are unlikely to occur, which is preferable. The content of ZnO is more preferably from 0 to 15%, still more preferably from 0 to 10%, yet still more preferably from 0 to 5%. Most preferably, ZnO is not substantially contained.

CuO is a component for cutting off near-infrared rays. The content of CuO is preferably from 2 to 30%. When the content of CuO is 2% or more, the effect thereof is sufficiently obtained, while when the content of CuO is 30% or less, problems such as reduction in transmittance in the visible light region and reduction in transmittance in the short-wavelength infrared region are unlikely to occur, which is preferable. The content of CuO is more preferably from 4 to 25%, still more preferably from 5 to 19%, yet still more preferably from 6 to 20%, further preferably 8% or more. Particularly, when the glass is substantially free of a divalent cation other than Cu, the near-infrared cut-off property and the transmission of short-wavelength infrared rays can be further improved by controlling the content of CuO to be 8% or more. The content of CuO is more preferably from 10 to 18%, most preferably from 11 to 18%.

Fe₂O₃ is a component for cutting off near-infrared rays. The content of Fe₂O₃ is preferably from 0.1% to 35%. When the content of Fe₂O₃ is less than 0.1%, the above-described effect is not sufficiently obtained, while when the content of Fe₂O₃ is more than 35%, the transmittance of light in the visible light region is reduced, which is not preferable. The content of Fe₂O₃ is preferably from 1 to 35%, more preferably from 2% to 35%, still more preferably from 3% to 35%, yet still more preferably from 4% to 35%, particularly preferably from 5% to 35%, most preferably from 6% to 35%.

B₂O₃ may be contained in a range of 15% or less for the purpose of stabilizing the glass. When the content of B₂O₃ is 15% or less, problems such as deterioration of the weather resistance of the glass, deterioration of the near-infrared cut-off property, and reduction in the transmission of short-wavelength infrared rays are unlikely to occur, which is preferable. The content of B₂O₃ is preferably 13% or less, more preferably 11% or less, still more preferably 9% or less, yet still more preferably 7% or less, and most preferably, B₂O₃ is not substantially contained.

In the glass of the present embodiment, F is a component effective for improving the weather resistance; however, since it is an environmentally hazardous substance and may cause deterioration of the near-infrared cut-off property, the glass of the present embodiment is substantially free of F. The term “substantially free of” used herein means that, when the content of component elements other than F in the glass is taken as 100% by mass and the content of F in the glass is expressed as an external basis, the content of F is less than 3% by mass in external basis.

In the glass of the present embodiment, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 5% or less for the purpose of improving the weather resistance of the glass. When the content of these components is 5% or less, problems such as deterioration of the near-infrared cut-off property and reduction in the transmission of short-wavelength infrared rays are unlikely to occur, which is preferable. The content of these components is preferably 4% or less, more preferably 3% or less, still more preferably 2% or less, yet still more preferably 1% or less.

From the standpoint of the ease of optical design for incorporating the phosphate glass into a camera module, the thickness of the phosphate glass is preferably 3 mm or less, more preferably 2 mm or less, still more preferably 1 mm or less and, from the standpoint of device strength and the necessity of obtaining desired optical characteristics, the thickness of the phosphate glass is preferably 0.1 mm or more.

The glass substrate 110 may have the spectral characteristics that satisfy the following conditions when converted to a thickness of 0.29 mm and at an incidence angle of 0°:
(i) an average transmittance T_{g(v)ave} in a wavelength range of 440 nm to 500 nm is 70% or more;
(ii) a transmittance T_{g(800)} at a wavelength of 800 nm is 7% or less;
(iii) a transmittance T_{g(1000)} at a wavelength of 1,000 nm is 7% or less; and
(iv) a transmittance T_{g(1200)} at a wavelength of 1,200 nm is 20% or less.

The T_{g(v)ave} is more preferably 75% or more, still more preferably 80% or more. The T_{g(800)} is more preferably 5% or less, still more preferably 3% or less. The T_{g(1000)} is more preferably 5% or less, still more preferably 3% or less. The T_{g(1200)} is more preferably 15% or less, still more preferably 10% or less.

### (First Barrier Layer 120 and Second Barrier Layer 130)

The first barrier layer 120 and the second barrier layer 130 are provided to protect the glass substrate 110 from the external environment. In other words, the glass substrate 110 composed of phosphate glass tends to elute when it comes into contact with water of the external environment. However, such elution can be significantly inhibited by covering the main surfaces 112 and 114 of the glass substrate 110 with the first barrier layer 120 and the second barrier layer 130, respectively.

As described above, the first barrier layer 120 and the second barrier layer 130 contain 80 mol % or more, preferably 90 mol % or more, more preferably 95 mol % or more, particularly preferably 100 mol % of an oxide of at least one metal selected from the group consisting of titanium (Ti), niobium (Nb), tantalum (Ta), and hafnium (Hf).

For example, resin materials are not preferable as the materials of the first barrier layer 120 and the second barrier layer 130 since they have lower properties to inhibit the penetration of water than inorganic materials.

Further, from the standpoint of improving the adhesion to the glass substrate 110, the first barrier layer 120 preferably contains 80 mol % or more of an oxide of at least one metal selected from the group consisting of titanium (Ti), niobium (Nb), tantalum (Ta), and hafnium (Hf). From the standpoint of improving the adhesion to the glass substrate 110, the second barrier layer 130 also preferably satisfies the condition in the same manner.

The first barrier layer 120 and the second barrier layer 130 may contain 80 mol % or more of a single oxide of at least one metal selected from the group consisting of titanium (Ti), niobium (Nb), tantalum (Ta), and hafnium (Hf), or may contain two or more kinds of materials in a total of 80 mol % or more.

Further, the first barrier layer 120 and the second barrier layer 130 may also contain a material other than metal oxides of titanium (Ti), niobium (Nb), tantalum (Ta), and hafnium (Hf) within a range that satisfies the condition and does not impair the resistance to water. For example, from the standpoint of adjusting the refractive indices of the first barrier layer 120 and the second barrier layer 130, an oxide of silicon (Si) may be incorporated. On the other hand, a layer containing silicon (Si) may deteriorate the adhesion to the glass substrate; therefore, the content of silicon (Si) is preferably as little as possible. Moreover, from the standpoint of improving the water resistance of the optical filter, the first barrier layer 120 and the second barrier layer 130 preferably do not contain any material other than metal oxides of titanium (Ti), niobium (Nb), tantalum (Ta), and hafnium (Hf).

The first barrier layer 120 and the second barrier layer 130 do not necessarily have to be composed of the same material.

However, it is preferable that the first barrier layer 120 and the second barrier layer 130 are both composed of titanium oxide. This is because titanium oxide barrier films are particularly effective protective barriers against water.

A method of forming the first barrier layer 120 and the second barrier layer 130 is not particularly limited. The first barrier layer 120 and the second barrier layer 130 may be formed by, for example, a method such as sputtering or vapor deposition.

A thickness of the first barrier layer 120 and that of the second barrier layer 130 are not particularly limited; however, from the standpoint of improving the water resistance of the optical filter, they are preferably 10 nm or more.

### (First Multilayer Film 150)

The first multilayer film 150 has a role of adjusting the optical characteristics of the first optical filter 100. For example, the first multilayer film 150 may function as an “anti-reflection film”.

The term “anti-reflection film” used herein means a layer configured such that, when light is incident at an incidence angle of 5° on a surface of the optical filter on which the anti-reflection film is disposed, a maximum reflectance of light at the surface in a wavelength between 450 nm and 1,200 nm is 45% or less.

The first multilayer film 150 is composed of a dielectric multilayer film. The first multilayer film 150 may be configured as a stack in which high-refractive-index layers and low-refractive-index layers are alternately disposed.

The material of the high-refractive-index layers may be selected from, for example, titania and alumina. Further, the material of the low-refractive-index layers may be selected from, for example, silica and magnesium fluoride.

The thickness of the first multilayer film 150 is, but not limited to, for example, in a range of 0.1 μm to 3 μm.

### (Second Multilayer Film 160)

The second multilayer film 160 has a role of adjusting the optical characteristics of the first optical filter 100 in cooperation with the second barrier layer 130. For example, the second multilayer film 160 may function as an “anti-reflection film” in cooperation with the second barrier layer 130.

It is noted here that the second multilayer film 160 may be formed by disposing in layers the same material as the first multilayer film 150 in the same manner.

The thickness of the second multilayer film 160 is, but not limited to, for example, in a range of 0.1 μm to 5 μm.

### (Resin Layer 140)

The resin layer 140 contains a resin and a dye that absorbs near-infrared rays.

The dye may be selected from, for example, a squarylium dye, a phthalocyanine dye, and a cyanine dye. The dye may also be selected to be at least one selected from the group consisting of a cyanine dye, a phthalocyanine dye, a squarylium dye, a naphthalocyanine dye, and a diimonium dye. Thereamong, a squarylium dye and a cyanine dye are preferable.

The resin layer 140 may contain two kinds of near-infrared absorbing dyes.

In this case, a first near-infrared absorbing dye may have a maximum absorption wavelength in a range of 700 to 730 nm, and/or a second near-infrared absorbing dye may have a maximum absorption wavelength in a range of 740 to 800 nm.

A content of a near-infrared absorbing dye in the resin layer 140 is preferably from 0.1 to 30 parts by mass, more preferably from 0.1 to 20 parts by mass, with respect to 100 parts by mass of the resin. When two or more kinds of compounds are used in combination, the above-described content is a sum of the compounds.

The resin layer 140 may also contain other dyes, such as a UV light absorbing dye, within a range that does not impair the effects of the invention.

Examples of the UV light absorbing dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Thereamong, a merocyanine dye is particularly preferable. These dyes may be used singly, or in combination of two or more kinds thereof.

The resin constituting the resin layer 140 is not particularly limited as long as it is transparent.

The resin may be selected from, for example, a polyester resin, an acrylic resin, an epoxy resin, an ene-thiol resin, a polycarbonate resin, a polyether resin, a polyarylate resin, a polysulfone resin, a polyether sulfone resin, a poly(p-phenylene) resin, a polyarylene ether phosphine oxide resin, a polyamide resin, a polyimide resin, a polyamide-imide resin, a polyolefin resin, a cyclic olefin resin, a polyurethane resin, and a polystyrene resin. These resins may be used singly, or as a mixture of two or more kinds thereof.

From the standpoint of the spectral characteristics, the glass transition temperature (Tg), and the adhesion of the resin layer 140, the resin is preferably selected from a polyimide resin, a polycarbonate resin, a polyester resin, and an acrylic resin.

### (First Optical Filter 100)

The first optical filter 100 may have optical characteristics that satisfy the following conditions:
(I) at an incidence angle θ=0°, an average transmittance Tₜ₍ᵥ₎ₐᵥₑ₁ in a wavelength range of 440 nm to 500 nm is 70% or more, and at an incidence angle θ=60°, an average transmittance Tₜ₍ᵥ₎ₐᵥₑ₂ in the wavelength range of 440 nm to 500 nm is 65% or more;
(II) at an incidence angle θ=0°, a wavelength λₜ₍ₜ₌₁₀₎₁ at which the transmittance is 10% is in a range of 600 nm to 700 nm;
(III) at an incidence angle θ=60°, an absolute value of a difference Δλₜ between a wavelength λₜ₍ₜ₌₁₀₎₂ at which the transmittance is 10% and the wavelength λₜ₍ₜ₌₁₀₎₁ is 12 nm or less; and
(IV) at an incidence angle θ=0°, an average transmittance Tₜ₍ᵢ₎ₐᵥₑ₁ in a wavelength range of 750 nm to 1,000 nm is 4% or less, and at an incidence angle θ=60°, an average transmittance Tₜ₍ᵢ₎ₐᵥₑ₂ in the wavelength range of 750 nm to 1,000 nm is 4% or less.

The Tₜ₍ᵥ₎ₐᵥₑ₁ is more preferably 75% or more, still more preferably 80% or more, yet still more preferably 85% or more, particularly preferably 90% or more. The Tₜ₍ᵥ₎ₐᵥₑ₂ is more preferably 70% or more, still more preferably 75% or more, yet still more preferably 80% or more. The λₜ₍ₜ₌₁₀₎₁ is more preferably in a range of 630 nm to 700 nm, still more preferably in a range of 650 nm to 700 nm. The absolute value of Δλₜ is more preferably 10 nm or less. The Tₜ₍ᵢ₎ₐᵥₑ₁ is more preferably 2% or less, still more preferably 1% or less. The Tₜ₍ᵢ₎ₐᵥₑ₂ is more preferably 2% or less, still more preferably 1% or less.

Further, the first optical filter 100 may have optical characteristics that satisfy the following conditions when light is incident from a side of the second multilayer film 160:
(V) at an incidence angle θ=5°, a maximum reflectance Rₜ₂ₘₐₓ₁ in a wavelength range of 450 nm to 950 nm is 10% or less; and
(VI) at an incidence angle θ=60°, a maximum reflectance Rₜ₂ₘₐₓ₂ in the wavelength range of 450 nm to 950 nm is 15% or less.

The Rₜ₂ₘₐₓ₁ is more preferably 8% or less, still more preferably 6% or less. The Rₜ₂ₘₐₓ₂ is more preferably 13% or less, still more preferably 12% or less.

Moreover, the first optical filter 100 may have optical characteristics that satisfy the following conditions when light is incident from a side of the first multilayer film 150:
(VII) at an incidence angle θ=5°, a maximum reflectance Rₜ₁ₘₐₓ₁ in a wavelength range of 450 nm to 950 nm is 35% or less; and
(VIII) at an incidence angle θ=60°, a maximum reflectance Rₜ₁ₘₐₓ₂ in the wavelength range of 450 nm to 950 nm is 35% or less.

By allowing the optical filter to have these optical characteristics, for example, when light reflected from the sensor side is incident on the optical filter, the reflection on the optical filter side can be inhibited, so that unnecessary light can be prevented from entering the sensor. The Rₜ₁ₘₐₓ₁ is more preferably 25% or less, still more preferably 15% or less, yet still more preferably 10% or less. The Rₜ₁ₘₐₓ₂ is more preferably 25% or less, still more preferably 22% or less, yet still more preferably 20% or less.

The first optical filter 100 may also have the following optical characteristic:
(IX) an absolute value of a difference ΔTₜ₍ᵥ₎ₐᵥₑ between the average transmittance Tₜ₍ᵥ₎ₐᵥₑ₁ and the average transmittance Tₜ₍ᵥ₎ₐᵥₑ₂ is 10% or less.

The ΔTₜ₍ᵥ₎ₐᵥₑ is more preferably 8% or less, still more preferably 7% or less.

In the first optical filter 100, a phosphate glass having a high infrared absorption function is used as the glass substrate 110 instead of a fluorophosphate glass; therefore, in order to obtain the above-described optical characteristics, it is not necessarily required to use an infrared reflective film on the second main surface 114 side of the glass substrate 110. The term “infrared reflective film” used herein means a layer configured to have, for light having a wavelength between 750 nm and 1,200 nm, a wavelength band with a width of 100 nm or more in which a reflectance is 80% or more at an incidence angle θ=5°.

In the optical filter disclosed in Patent Document 1, it is required to use an infrared reflective film for improving the infrared-blocking function in the infrared region. However, the use of an infrared reflective film may cause an “angle dependency problem” in which the optical characteristics vary depending on the incidence angle of light.

In contrast, in the first optical filter 100, it is not necessarily required to use an infrared reflective film. For example, the second multilayer film 160 can be configured as an anti-reflection film in conjunction with the second barrier layer 130. In this case, the first optical filter 100 can be provided with the above-described optical characteristics (V) and (VI); therefore, the “angle dependency problem” can be alleviated.

### (Optical Filter According to Another Embodiment of Invention)

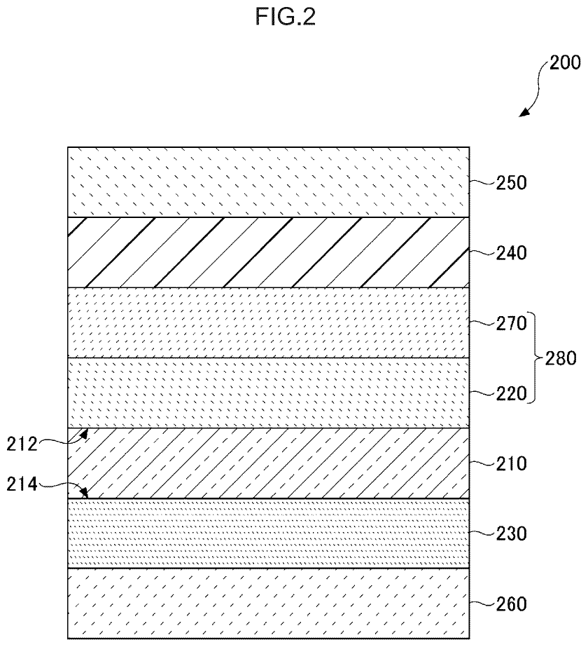

Next, the configuration of an optical filter according to another embodiment of the invention will be described with reference to FIG. 2.

FIG. 2 schematically illustrates a cross-section of the configuration of the optical filter according to another embodiment of the invention.

As illustrated in FIG. 2, an optical filter 200 according to another embodiment of the invention (hereinafter, referred to as “second optical filter”) has a configuration similar to that of the above-described first optical filter 100. Accordingly, in the second optical filter 200, those portions that are the same as in the first optical filter 100 are designated by reference numerals obtained by adding 100 to the respective reference numerals used in FIG. 1.

For example, the second optical filter 200 includes a glass substrate 210, a first barrier layer 220, a second barrier layer 230, a resin layer 240, a first multilayer film 250, and a second multilayer film 260.

However, the second optical filter 200 is different from the first optical filter 100 in that it further includes a third multilayer film 270 between the first barrier layer 220 and the resin layer 240 on the side of a first main surface 212 of the glass substrate 210.

The third multilayer film 270 is composed of plural dielectric layers. For example, the third multilayer film 270 may be configured as a stack in which high-refractive-index layers and low-refractive-index layers are alternately disposed.

In the second optical filter 200, the glass substrate 210 is composed of a phosphate glass containing an infrared absorber. Therefore, the second optical filter 200 can exhibit significantly high light-blocking performance in the infrared region.

Further, in the second optical filter 200, the first barrier layer 220 is arranged on the first main surface 212 of the glass substrate 210, and the second barrier layer 230 is arranged on the second main surface 214. The first barrier layer 220 and the second barrier layer 230 are composed of the above-described materials.

Therefore, in the second optical filter 200 as well, the problem of elution of the glass substrate 210 caused by reaction with water of the external environment can be significantly reduced.

In the second optical filter 200, X, that is a value with respect to a portion composed of the first barrier layer 220 and the third multilayer film 270 and is represented by the following Formula (1), is 35% or more.

$$X ( \% ) = \{ A / ( B - C ) \} \times 100 \qquad ( 1 )$$

In Formula (1), A (nm) is a total thickness of dielectric layers, among the layers included in a laminated portion 280, that satisfy both a QWOT of less than 2 and a refractive index of 1.9 or less, as determined by evaluating each layer included in the laminated portion 280 using QWOT represented by the following Formula (2).

$$QWOT = ( thickness of layer of interest / 550 nm ) \times 4 \times Refractive index at wavelength of 550 nm , \qquad ( 2 )$$

B (nm) is the entire thickness of the laminated portion 280, and
C (nm) is a total thickness of layers, among the layers included in the laminated portion 280, that having a QWOT of 2 or more.

When the laminated portion 280 is configured in this manner, the effects of undesirable reflection behavior at the interface between the first barrier layer 220 and the resin layer 240 can be reduced, so that an optical filter having more favorable spectral characteristics can be obtained.

By inhibiting the above-described reflection behavior, for example, the maximum reflectance of light incident from the side of the first multilayer film 250, which is represented by the optical characteristics (VII) and (VIII) of the optical filter, can be reduced. As described above, by reducing the maximum reflectance of light incident from the side of the first multilayer film 250, the intrusion of unnecessary light into the optical filter can be inhibited.

Particularly, from the standpoint of improving the water resistance of the optical filter and preventing film deformation in the event of deterioration of the glass surface, the laminated portion 280 has a thickness of preferably 0.2 μm or more, more preferably 0.5 μm or more, still more preferably 1.0 μm or more, yet still more preferably 1.5 μm or more.

When the laminated portion 280 has a layer composed of SiO₂, X′ represented by the following Formula (3) in the laminated portion 280 may be 35% or more.

$${X}^{′} ( \% ) = \{ {A}^{′} / ( {B}^{′} - {C}^{′} ) \} \times 100 \qquad ( 3 )$$

The X′ (%) is more preferably 50% or more, still more preferably 70% or more.

In Formula (3),
A′ (nm) is a total thickness of SiO₂ layers included in the laminated portion 280 that have a thickness of 180 nm or less,
B′ (nm) is the total thickness of the laminated portion 280, and
C′ (nm) is a total thickness of SiO₂ layers included in the laminated portion 280 that have a thickness of more than 180 nm.

### (Method of Producing Optical Filter According to One Embodiment of Invention)

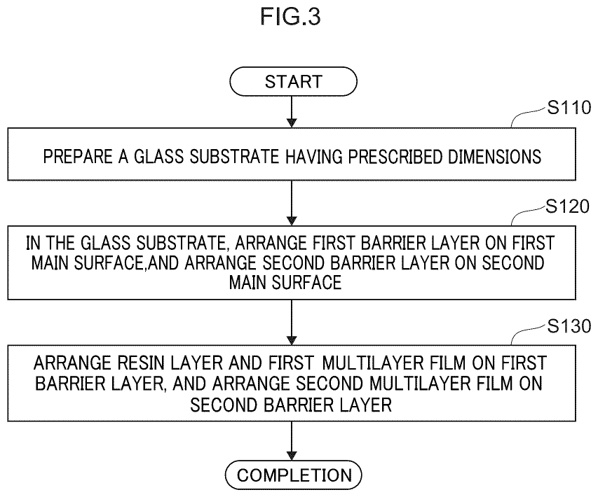

Next, one example of the method of producing an optical filter according to one embodiment of the invention will be described with reference to FIG. 3. FIG. 3 is a flow chart that schematically illustrates one example of the method of producing an optical filter according to one embodiment of the invention.

As illustrated in FIG. 3, the method of producing an optical filter according to one embodiment of the invention (hereinafter, referred to as “first method”) includes:
preparing a glass substrate having prescribed dimensions (Step S110);
arranging a first barrier layer on a first main surface of the glass substrate, and arranging a second barrier layer on a second main surface of the glass substrate (Step S120); and
arranging a resin layer and a first multilayer film on the first barrier layer, and arranging a second multilayer film on the second barrier layer (Step S130).

These steps will now be described.

It is noted here that the above-described first optical filter 100 is taken as an example to describe its production method. Accordingly, the reference numerals in FIG. 1 are used for describing the respective components.

### (Step S110)

First, a glass substrate is prepared. As described above, the glass substrate 110 has the first main surface 112 and the second main surface 114, and is composed of a phosphate glass containing an infrared absorber.

### (Step S120)

Next, the first barrier layer 120 is arranged on the first main surface 112 of the glass substrate 110, and the second barrier layer 130 is arranged on the second main surface 114.

The first barrier layer 120 and the second barrier layer 130 (hereinafter, these layers are also collectively referred to as “barrier layers”) may be composed of the same material or different materials. For example, both of these barrier layers may be composed of titanium oxide.

A method of forming the barrier layers is not particularly limited. The barrier layers may be formed by, for example, a vapor deposition method or a sputtering method.

### (Step S130)

Subsequently, components required for the first optical filter 100 are sequentially formed on the glass substrate 110. Specifically, the resin layer 140 and the first multilayer film 150 are sequentially arranged on the first barrier layer 120, and the second multilayer film 160 is arranged on the second barrier layer 130.

As described above, the first multilayer film 150 is formed by alternately forming high-refractive-index films and low-refractive-index films, and may function as an anti-reflection film.

A method of forming the first multilayer film 150 is not particularly limited. For example, a general film-forming method such as a sputtering method may be employed.

The resin layer 140 is formed from, for example, a dye-containing resin solution.

The resin solution may be prepared by dissolving a dye in a solution that contains a resin, an organic solvent, and the like. The dye may include the above-described infrared-absorbing dye and UV-absorbing dye.

Next, the resin solution is applied onto the first barrier layer 120 by a coating method such as spin coating. The resulting coating film is subsequently dried to form the resin layer 140.

Thereafter, the second multilayer film 160 is arranged on the resin layer 140.

The second multilayer film 160 can be formed in the same manner as the first multilayer film 150. The second multilayer film 160 may also function as an anti-reflection film.

The first optical filter 100 can be produced by the above-described steps.

It is noted here that the above-described method is merely one example, and it is obvious to those skilled in the art that the first optical filter 100 may be produced by other production method.

For example, in the first method, the barrier layers 120 and 130 are formed on the respective main surfaces 112 and 114 of the glass substrate 110 in the step S120, after which the remaining layers are arranged in the step S130.

However, apart from this, the second barrier layer 130 and the second multilayer film 160 may be formed on the second main surface 114 of the glass substrate 110, and then the necessary layers may be sequentially formed on the first main surface 112 of the glass substrate 110. Alternatively, conversely, all of the necessary layers may be formed on the first main surface 112 of the glass substrate 110, and then the necessary layers may be sequentially formed on the second main surface 114 of the glass substrate 110.

Further, in the case of producing the second optical filter 200, the third multilayer film 270 is arranged before the resin layer 140 is arranged on the first barrier layer 120 in the step S130 of the first method. Subsequently, the resin layer 240 and the first multilayer film 250 may be sequentially arranged on the third multilayer film 270.

In addition to the above, various modifications can be made.

The optical filter according to one embodiment of the invention can be applied to, for example, an imaging device such as a digital still camera. Such an imaging device can be provided with favorable color reproducibility.

An imaging device equipped with the optical filter according to one embodiment of the invention may further include a solid-state image sensor and an imaging lens, and the optical filter may be arranged, for example, between the imaging lens and the solid-state image sensor. Further, the optical filter according to one embodiment of the invention may be directly attached to the solid-state image sensor and/or the imaging lens of the imaging device via, for example, an adhesive layer.

### EXAMPLES

### (Preliminary Test 1)

In order to evaluate the effects of the first and the second barrier layers used in the optical filter according to one embodiment of the invention, the following Experiments 1 to 5 were performed.

### (Experiment 1)

A glass substrate having a first main surface and a second main surface both covered with a barrier layer was produced by the following method.

First, a glass substrate of 5 mm in length×5 mm in width×0.29 mm in thickness was prepared. As the glass substrate, a phosphate glass having the composition shown as “Glass A” in Table 1 below was used.

TABLE 1

| % by mass | Glass A | Glass B | Glass C | Glass D | Glass E | Glass F |
|---|---|---|---|---|---|---|
| P₂O₅ | 57.69 | 63.70 | 64.31 | 60.54 | 60.54 | 23.34 |
| Al₂O₃ | 13.27 | 24.26 | 25.45 | 23.96 | 19.96 | 5.35 |
| LiO₂ | 0.00 | 0.00 | 0.00 | 0.00 | 0.00 | 15.06 |
| Na₂O | 6.08 | 1.79 | 1.80 | 5.25 | 5.25 | 0.00 |
| K₂O | 11.46 | 0.00 | 0.00 | 0.00 | 0.00 | 0.00 |
| ZnO | 0.00 | 1.90 | 0.00 | 0.00 | 3.00 | 0.00 |
| SnO₂ | 0.00 | 0.00 | 0.00 | 0.00 | 1.00 | 0.00 |
| MoO₃ | 0.00 | 0.00 | 0.00 | 0.00 | 0.00 | 0.00 |
| MgO | 0.00 | 0.00 | 0.00 | 0.00 | 0.00 | 3.73 |
| CaO | 0.00 | 0.00 | 0.00 | 0.00 | 0.00 | 5.39 |
| SrO | 0.00 | 0.00 | 0.00 | 0.00 | 0.00 | 6.66 |
| BaO | 0.00 | 0.00 | 0.00 | 0.00 | 0.00 | 7.03 |
| CuO | 11.50 | 8.36 | 8.44 | 10.25 | 10.25 | 3.40 |
| F | 0.00 | 0.00 | 0.00 | 0.00 | 0.00 | 30.04 |
| Total | 100.0 | 100.0 | 100.0 | 100.0 | 100.0 | 100.0 |

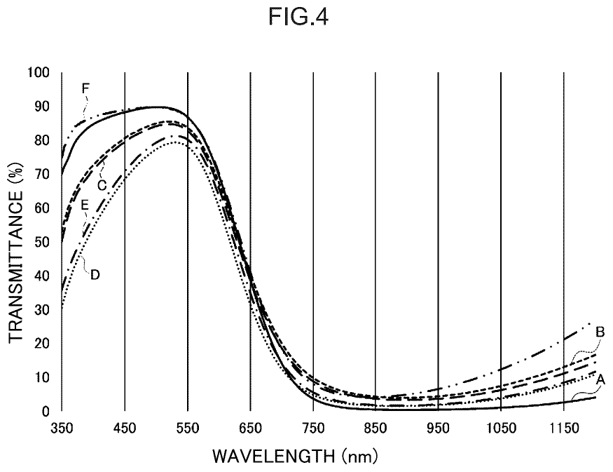

The optical characteristics of the glass substrate A used are shown in curve A of FIG. 4. The column for Glass Ain Table 2 below indicates parameters corresponding to the above-described (i) to (iv), which were calculated from the measured optical characteristics.

TABLE 2

| | Glass | | | | | |
|---|---|---|---|---|---|---|
| Optical parameters | A | B | C | D | E | F |
| Average transmittance T_{g(v)ave} | 88.9 | 82.4 | 81.4 | 72.2 | 74.4 | 89.2 |
| Transmittance T_{g(800)} | 1.0 | 5.8 | 5.1 | 2.3 | 2.6 | 4.7 |
| Transmittance T_{g(1000)} | 0.6 | 5.5 | 4.6 | 2.5 | 2.7 | 9.0 |
| Transmittance T_{g(1200)} | 4.0 | 16.6 | 14.3 | 10.7 | 11.6 | 26.9 |

Subsequently, a first barrier layer was formed on the first main surface of the glass substrate by a vapor deposition method. The first barrier layer was a titania layer having a thickness of 143 nm.

In the same manner, a second barrier layer was formed on the second main surface of the glass substrate. The second barrier layer was a titania layer having a thickness of 143 nm.

Then, using the glass substrate covered with the first and the second barrier layers (hereinafter, referred to as the “covered substrate”), a high-temperature high-humidity test was conducted for 100 hours and 250 hours. The test temperature was set at 85° C., and the relative humidity was set at 85%.

### (Experiment 2)

The same experiment as Experiment 1 was performed.

However, in this Experiment 2, tantalum oxide layers were used as the first and the second barrier layers.

### (Experiment 3)

The same experiment as Experiment 1 was performed.

However, in this Experiment 3, alumina layers were used as the first and the second barrier layers.

### (Experiment 4)

The same experiment as Experiment 1 was performed.

However, in this Experiment 4, silica layers were used as the first and the second barrier layers.

### (Experiment 5)

The same experiment as Experiment 1 was performed.

However, in this Experiment 5, zirconia layers were used as the first and the second barrier layers.

### (Evaluation)

After each experiment, the covered substrate was taken out, and the following evaluation of barrier property was performed using a microscope.

The covered substrate is observed from the first main surface side using a microscope. At a location where the glass substrate inside the first main surface is most severely eroded, a distance from the nearest end surface is measured. The barrier property is evaluated as: “A (excellent)” when the measured distance is less than 150 μm; “B (favorable)” when the measured distance is from 150 μm to 200 μm; or “C (poor)” when the measured distance is more than 200 μm.

The results of the experiments are summarized in Table 3 below.

TABLE 3

Evaluation Results

| Experiment | Barrier Layer | 100 hours | 250 hours |
|---|---|---|---|
| 1 | TiO₂ | A | A |
| 2 | Ta₂O₅ | A | B |
| 3 | Al₂O₃ | C | C |
| 4 | SiO₂ | C | C |
| 5 | ZrO₂ | C | C |

From these results, it is seen that the elution of glass was hardly inhibited even with the use of alumina, silica, or zirconia as the barrier layers. On the other hand, it was found that the elution of glass was significantly inhibited when titania or tantalum oxide was used as the barrier layers. Particularly, it was found that the elution of glass was inhibited over a longer period when titania was used as the barrier layers.

### (Preliminary Test 2)

Next, in order to evaluate the effects of the third multilayer film (see FIG. 2) used in the optical filter according to one embodiment of the invention, the following Experiments 10 and 11 were performed.

### (Experiment 10)

A glass substrate having both main surfaces covered with a barrier layer and a multilayer film was produced by the following method.

First, a glass substrate of 5 mm in length×5 mm in width×0.29 mm in thickness was prepared. As the glass substrate, a phosphate glass having the composition shown as “Glass A” in Table 1 above was used.

Next, a first barrier layer and a multilayer film A were continuously formed on a first main surface of the glass substrate by a vapor deposition method.

The first barrier layer was a titania layer having a thickness of 11.49 nm. The multilayer film A was formed as alternating layers of silica and titania.

Table 4 below shows the layer configuration of the multilayer film A.

TABLE 4

| Layer No. | Material | Thickness (nm) |
|---|---|---|
| 1 | SiO₂ | 57.88 |
| 2 | TiO₂ | 23.98 |
| 3 | SiO₂ | 60.37 |
| 4 | TiO₂ | 20.17 |
| 5 | SiO₂ | 89.86 |
| 6 | TiO₂ | 12.96 |
| 7 | SiO₂ | 80.19 |
| 8 | TiO₂ | 26.77 |
| 9 | SiO₂ | 28.54 |
| 10 | TiO₂ | 80.07 |
| 11 | SiO₂ | 13.91 |
| 12 | TiO₂ | 31.37 |
| 13 | SiO₂ | 1,107.65 |

| | |
|---|---|
| Total thickness | 1,633.72 |

In Table 4, the layer numbers listed in order of proximity from the barrier layer (note that the same notation is used in the table below showing the configuration of the multilayer film). The total thickness of the first barrier layer and the multilayer film A was about 1,645 nm.

In the same manner, on the second main surface side of the glass substrate, a second barrier layer (titania layer: thickness=11.49 nm) and the multilayer film A were continuously formed by a vapor deposition method. The total thickness of the second barrier layer and the multilayer film A was about 1,645 nm.

As a result, a test sample (hereinafter, referred to as “sample 1”) was obtained.

### (Experiment 11)

A test sample (hereinafter, referred to as “sample 2”) was prepared in the same manner as in Experiment 10.

However, in this Experiment 11, a multilayer film B having the layer configuration shown in Table 5 below was used as the multilayer film. On both sides of the glass substrate, the total thickness of the barrier layer and the multilayer film B was about 645 nm.

TABLE 5

| Layer No. | Material | Thickness (nm) |
|---|---|---|
| 1 | SiO₂ | 57.88 |
| 2 | TiO₂ | 23.98 |
| 3 | SiO₂ | 60.37 |
| 4 | TiO₂ | 20.17 |
| 5 | SiO₂ | 89.86 |
| 6 | TiO₂ | 12.96 |
| 7 | SiO₂ | 80.19 |
| 8 | TiO₂ | 26.77 |
| 9 | SiO₂ | 28.54 |
| 10 | TiO₂ | 80.07 |
| 11 | SiO₂ | 13.91 |
| 12 | TiO₂ | 31.37 |
| 13 | SiO₂ | 107.65 |

| | |
|---|---|
| Total thickness | 633.72 |

### (Evaluation)

The above-described high-temperature high-humidity test was conducted using the samples 1 and 2.

The results obtained for the samples 1 and 2 are summarized in Table 6 below.

TABLE 6

| | | | Evaluation Results | |
|---|---|---|---|---|
| Experiment | Barrier Layer | Multilayer film | 100 hours | 250 hours |
| 10 | TiO₂ | A | A | A |
| 11 | TiO₂ | B | A | B |

In Table 6, “A” to “C” correspond to the evaluation criteria used in the above-described Preliminary Test 1.

From these results, it was found that no significant elution occurred in the glass substrate in both of the samples. Particularly, in the sample 1, a superior anti-glass elution effect was obtained. This is presumably because the multilayer film A used in the sample 1 was thicker than the multilayer film B used in the sample 2 and, therefore, the glass elution-inhibiting effect attributed to the barrier layer was combined with the elution-inhibiting effect attributed to the multilayer film A.

### EXAMPLES

Examples of the invention will now be described. It is noted here that, in the following description, Examples 1 to 9 are working examples, and Example 10 is a reference example.

### Example 1

An optical filter was produced by the following method.

First, a second barrier layer and a second multilayer film (anti-reflection film) were formed on the side of a second main surface of a glass substrate by the same method as in the above-described Experiment 10.

As the glass substrate, a phosphate glass having the composition shown as “Glass A” in Table 1 above was used.

The second barrier layer was 12 nm-thick titania. The second multilayer film was formed as alternating layers of silica and titania.

Table 7 below shows the configuration of the second multilayer film.

TABLE 7

Second multilayer film

| Layer No. | Material | Thickness (nm) |
|---|---|---|
| 1 | SiO₂ | 56.46 |
| 2 | TiO₂ | 19.47 |
| 3 | SiO₂ | 61.02 |
| 4 | TiO₂ | 10 |
| 5 | SiO₂ | 2,000 |
| 6 | TiO₂ | 10 |
| 7 | SiO₂ | 71.06 |
| 8 | TiO₂ | 17.37 |
| 9 | SiO₂ | 79.72 |
| 10 | TiO₂ | 13.04 |
| 11 | SiO₂ | 108.92 |
| 12 | TiO₂ | 11.45 |
| 13 | SiO₂ | 82 |
| 14 | TiO₂ | 27.13 |
| 15 | SiO₂ | 34.26 |
| 16 | TiO₂ | 59.11 |
| 17 | SiO₂ | 23.31 |
| 18 | TiO₂ | 32.71 |
| 19 | SiO₂ | 113.9 |

| | |
|---|---|
| Total | 2,831 |

Next, a first barrier layer and a third multilayer film were formed on the first main surface side of the glass substrate.

The first barrier layer was 12 nm-thick titania. The third multilayer film was formed as alternating layers of silica and titania. The total thickness of the first barrier layer and the third multilayer film was 2,154 nm.

The columns of Configuration I-1 in Table 8 below show the configuration of the third multilayer film.

TABLE 8

Configuration I-1

| Layer No. | Material | Thickness (nm) | QWOT |
|---|---|---|---|
| 1 | SiO₂ | 53.25 | 0.57 |
| 2 | TiO₂ | 20.65 | 0.37 |
| 3 | SiO₂ | 58.15 | 0.62 |
| 4 | TiO₂ | 10 | 0.18 |
| 5 | SiO₂ | 2,000 | 21.34 |

| | |
|---|---|
| Total | 2,142.05 |

Configuration I-2

| Layer No. | Material | Thickness (nm) | QWOT |
|---|---|---|---|
| 1 | SiO₂ | 36.6 | 0.39 |
| 2 | TiO₂ | 35 | 0.63 |
| 3 | SiO₂ | 38.95 | 0.42 |
| 4 | TiO₂ | 15.45 | 0.28 |
| 5 | SiO₂ | 2000 | 21.34 |

| | |
|---|---|
| Total | 2,116 |

Configuration I-3

| Layer No. | Material | Thickness (nm) | QWOT |
|---|---|---|---|
| 1 | SiO₂ | 25 | 0.27 |
| 2 | TiO₂ | 49.98 | 0.90 |
| 3 | SiO₂ | 25 | 0.27 |
| 4 | TiO₂ | 17.88 | 0.32 |
| 5 | SiO₂ | 2,000 | 21.34 |

| | |
|---|---|
| Total | 2,117.86 |

Configuration I-4

| Layer No. | Material | Thickness (nm) | QWOT |
|---|---|---|---|
| 1 | SiO₂ | 20 | 0.21 |
| 2 | TiO₂ | 74.83 | 1.35 |
| 3 | SiO₂ | 20 | 0.21 |
| 4 | TiO₂ | 15.27 | 0.27 |
| 5 | SiO₂ | 2,000 | 21.34 |

| | |
|---|---|
| Total | 2,130.1 |

Configuration I-5

| Layer No. | Material | Thickness (nm) | QWOT |
|---|---|---|---|
| 1 | SiO₂ | 10.98 | 0.12 |
| 2 | TiO₂ | 60.47 | 1.09 |
| 3 | SiO₂ | 11 | 0.12 |
| 4 | TiO₂ | 16.19 | 0.29 |
| 5 | SiO₂ | 2,000 | 21.34 |

| | |
|---|---|
| Total | 2,098.64 |

Next, a resin layer was formed on the third multilayer film by the following method.

First, a liquid for the resin layer was prepared. The liquid for the resin layer was prepared as follows.

A polyimide resin (C3G30G, refractive index: 1.59, manufactured by Mitsubishi Gas Chemical Company, Inc.) was dissolved in a mixture of γ-butyrolactone (GBL):cyclohexanone=1:1 (mass ratio) to prepare a solution having a resin concentration of 8.5% by mass.

Next, to the thus obtained diluted solution, a compound A, a compound B, and a compound C were added as pigments and dissolved with stirring at 50° C. for 2 hours, whereby a liquid for the resin layer was prepared.

The amounts of the added compounds A, B, and C were 3.99% by mass, 2.25% by mass, and 6.89% by mass, respectively, with respect to the amount of the resin.

Table 9 below summarizes the specifications of the compounds A, B, and C.

TABLE 9

| | Maximum | | |
|---|---|---|---|
| | absorption | Dye | |
| Compound | wavelength | classification | Reference |
| A | 772 | cyanine | Dyes and |
| | | compound | Pigments, 73, |
| | | | 344-352 (2007) |
| B | 713 | squarylium | Japanese Patent |
| | | compound | Application |
| | | | Laid-Open (JP-A) |
| | | | No. 2017-110209 |
| C | 397 | merocyanine | Germany Patent |
| | | compound | Application |
| | | | Publication |
| | | | No. 10109243 |

The compounds A, B, and C have the following respective formulae.

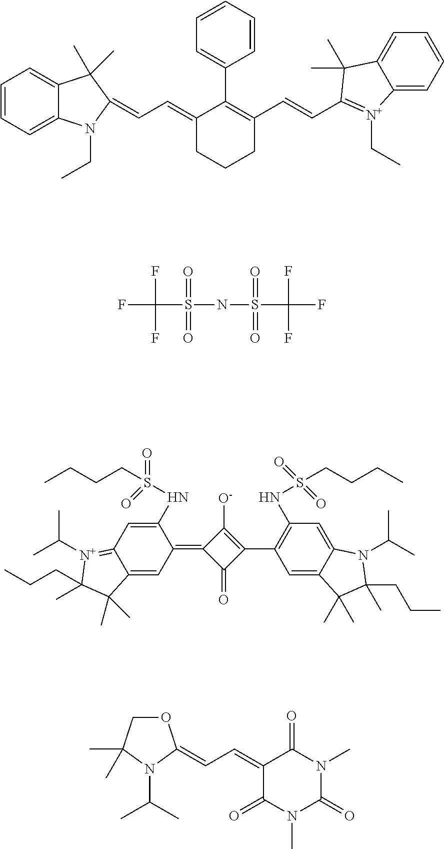

Next, the liquid for the resin layer was spin-coated on the third multilayer film. The target thickness was 1 μm. Subsequently, the liquid for the resin layer was dried to form a resin layer.

Thereafter, a first multilayer film (anti-reflection film) was formed on the resin layer.

Table 10 below shows the configuration of the first multilayer film.

TABLE 10

First multilayer film

| Layer No. | Material | Thickness (nm) |
|---|---|---|
| 1 | TiO₂ | 9.11 |
| 2 | SiO₂ | 63.49 |
| 3 | TiO₂ | 24.2 |
| 4 | SiO₂ | 25.88 |
| 5 | TiO₂ | 77.82 |
| 6 | SiO₂ | 13.38 |
| 7 | TiO₂ | 29.12 |
| 8 | SiO₂ | 105.16 |

| | |
|---|---|
| Total | 348.2 |

An optical filter was obtained in the above-described manner. The thus obtained optical filter is hereinafter referred to as “optical filter 1”.

### Example 2

An optical filter was produced in the same manner as in Example 1. However, in this Example 2, the thickness of the first barrier layer was 15.89 nm, and the configuration of the third multilayer film was changed from that in Example 1.

The columns of Configuration I-2 in Table 8 above show the configuration of the third multilayer film used in Example 2.

As a result, an optical filter was obtained. The thus obtained optical filter is hereinafter referred to as “optical filter 2”.

### Example 3

An optical filter was produced in the same manner as in Example 1. However, in this Example 3, the thickness of the first barrier layer was 17.54 nm, and the configuration of the third multilayer film was changed from that in Example 1.

The columns of Configuration I-3 in Table 8 above show the configuration of the third multilayer film used in Example 3.

As a result, an optical filter was obtained. The thus obtained optical filter is hereinafter referred to as “optical filter 3”.

### Example 4

An optical filter was produced in the same manner as in Example 1. However, in this Example 4, the thickness of the first barrier layer was 15.24 nm, and the configuration of the third multilayer film was changed from that in Example 1.

The columns of Configuration I-4 in Table 8 above show the configuration of the third multilayer film used in Example 4.

As a result, an optical filter was obtained. The thus obtained optical filter is hereinafter referred to as “optical filter 4”.

### Example 5

An optical filter was produced in the same manner as in Example 1. However, in this Example 5, the thickness of the first barrier layer was 13.25 nm, and the configuration of the third multilayer film was changed from that in Example 1.

The columns of Configuration I-5 in Table 8 above show the configuration of the third multilayer film used in Example 5.

As a result, an optical filter was obtained. The thus obtained optical filter is hereinafter referred to as “optical filter 5”.

### Example 6

An optical filter was produced in the same manner as in Example 1. However, in this Example 6, a phosphate glass having the composition shown as “Glass B” in Table 1 above was used as the glass substrate. The curve B in FIG. 4 indicates the optical characteristics of Glass B. Further, the column of Glass B in Table 2 above indicates various parameters calculated from the measured optical characteristics.

Thereafter, an optical filter was produced by the same steps as in Example 1.

The thus obtained optical filter is hereinafter referred to as “optical filter 6”.

### Example 7

An optical filter was produced in the same manner as in Example 1. However, in this Example 7, a phosphate glass having the composition shown as “Glass C” in Table 1 above was used as the glass substrate. The curve C in FIG. 4 indicates the optical characteristics of Glass C. Further, the column of Glass C in Table 2 above indicates various parameters calculated from the measured optical characteristics.

Thereafter, an optical filter was produced by the same steps as in Example 1.

The thus obtained optical filter is hereinafter referred to as “optical filter 7”.

### Example 8

An optical filter was produced in the same manner as in Example 1. However, in this Example 8, a phosphate glass having the composition shown as “Glass D” in Table 1 above was used as the glass substrate. The curve D in FIG. 4 indicates the optical characteristics of Glass D. Further, the column of Glass D in Table 2 above indicates various parameters calculated from the measured optical characteristics.

Thereafter, an optical filter was produced by the same steps as in Example 1.

The thus obtained optical filter is hereinafter referred to as “optical filter 8”.

### Example 9

An optical filter was produced in the same manner as in Example 1. However, in this Example 9, a phosphate glass having the composition shown as “Glass E” in Table 1 above was use as the glass substrate d. The curve E in FIG. 4 indicates the optical characteristics of Glass E. Further, the column of Glass E in Table 2 above indicates various parameters calculated from the measured optical characteristics.

Thereafter, an optical filter was produced by the same steps as in Example 1.

The thus obtained optical filter is hereinafter referred to as “optical filter 9”.

### Example 10

An optical filter was produced in the same manner as in Example 1. However, in this Example 10, a fluorophosphate glass having the composition shown as “Glass F” in Table 1 above was used as the glass substrate. The curve F in FIG. 4 indicates the optical characteristics of Glass F. Further, the column of Glass F in Table 2 above indicates various parameters calculated from the measured optical characteristics.

Thereafter, an optical filter was produced by the same steps as in Example 1.

The thus obtained optical filter is hereinafter referred to as “optical filter 10”.

Table 11 below summarizes the configuration of each optical filter, the value of X defined as described above, and the like.

TABLE 11

| | | | | | | Total | | |
|---|---|---|---|---|---|---|---|---|
| | | | | | | thickness | | |
| | | | | | | of first | | |
| | | | | | | barrier | | |
| | | First barrier layer | | | Configuration | layer | | |
| | | | | Content | of third | and third | X | X′ |
| Optical | Glass | | Thickness | ratio | multilayer | multilayer | value | value |
| filter | substrate | Material | (nm) | (mol %) | film | film (nm) | (%) | (%) |
| 1 | A | TiO₂ | 12 | 100 | I-1 | 2,154.05 | 72.3 | 72.3 |
| 2 | A | TiO₂ | 15.89 | 100 | I-2 | 2,133.75 | 53.2 | 53.2 |
| 3 | A | TiO₂ | 17.54 | 100 | I-3 | 2,116.18 | 36.9 | 36.9 |
| 4 | A | TiO₂ | 15.24 | 100 | I-4 | 2,141.24 | 27.5 | 27.5 |
| 5 | A | TiO₂ | 13.25 | 100 | I-5 | 2,143.35 | 19.6 | 19.6 |
| 6 | B | TiO₂ | 12 | 100 | I-1 | 2,154.05 | 72.3 | 72.3 |
| 7 | C | TiO₂ | 12 | 100 | I-1 | 2,154.05 | 72.3 | 72.3 |
| 8 | D | TiO₂ | 12 | 100 | I-1 | 2,154.05 | 72.3 | 72.3 |
| 9 | E | TiO₂ | 12 | 100 | I-1 | 2,154.05 | 72.3 | 72.3 |
| 10 | F | TiO₂ | 12 | 100 | I-1 | 2,154.05 | 72.3 | 72.3 |

| | Second barrier layer | | | Configuration | Configuration | |
|---|---|---|---|---|---|---|
| | | | Content | of second | of first | |
| Optical | | Thickness | ratio | multilayer | multilayer | Durability |
| filter | Material | (nm) | (mol %) | film | film | test |
| 1 | TiO₂ | 12 | 100 | Table 7 | Table 10 | A |
| 2 | TiO₂ | 12 | 100 | Table 7 | Table 10 | — |
| 3 | TiO₂ | 12 | 100 | Table 7 | Table 10 | — |
| 4 | TiO₂ | 12 | 100 | Table 7 | Table 10 | — |
| 5 | TiO₂ | 12 | 100 | Table 7 | Table 10 | — |
| 6 | TiO₂ | 12 | 100 | Table 7 | Table 10 | A |
| 7 | TiO₂ | 12 | 100 | Table 7 | Table 10 | A |
| 8 | TiO₂ | 12 | 100 | Table 7 | Table 10 | A |
| 9 | TiO₂ | 12 | 100 | Table 7 | Table 10 | A |
| 10 | TiO₂ | 12 | 100 | Table 7 | Table 10 | A |

### (Evaluation)

The following evaluations were performed using each optical filter.

### (Evaluation of Durability)

The above-described high-temperature high-humidity test was conducted using each optical filter. The test time was 250 hours.

As a result of observation after the test, all of the optical filters were found with almost no elution in the glass substrate. Accordingly, based on the above-described criteria, an evaluation of “A” was given to all of the optical filters.

### (Evaluation of Optical Characteristics)

The optical characteristics were evaluated using each optical filter. For the measurement, a UV-visible-near infrared spectrophotometer (UH4150: manufactured by Hitachi High-Tech Science Corporation) was used.

In the measurement of the transmittance, light was incident on the first multilayer film side of each optical filter.

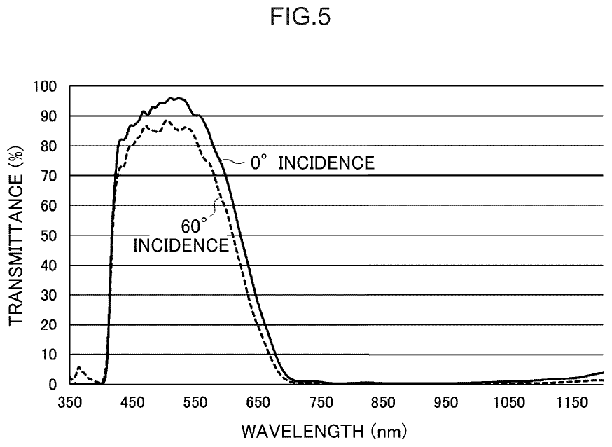

FIG. 5 provides one example of the transmittance profile obtained for the optical filter 1. In FIG. 5, the abscissa represents wavelength, and the ordinate represents transmittance. FIG. 5 provides the results obtained at both incidence angles θ=0° and θ=60°.

As shown in FIG. 5, it is seen that, in the optical filter 1, almost no influence of the incidence angle θ on the transmittance profile is observed. In other words, a high transmittance was obtained in the visible light region, regardless of the incidence angle θ. In addition, even when the incidence angle θ was changed, the region in which the transmittance sharply decreases remained almost unchanged. Further, the optical filter 1 was found to exhibit a low transmittance in the infrared region, regardless of the incidence angle θ.

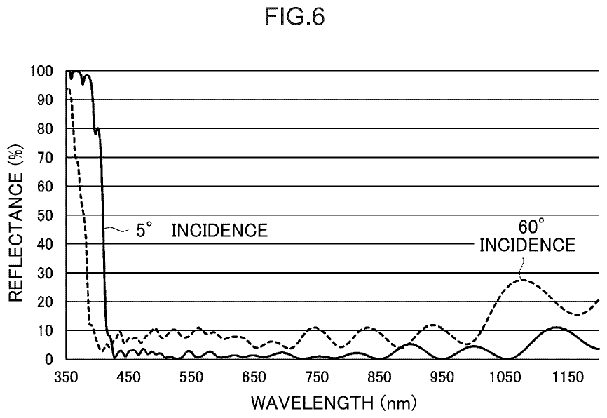

FIG. 6 provides one example of the reflectance profile obtained in the optical filter 1 for light incident from the second multilayer film side. In FIG. 6, the abscissa represents wavelength, and the ordinate represents reflectance. FIG. 6 provides the results obtained at both incidence angles θ=5° and θ=60°.

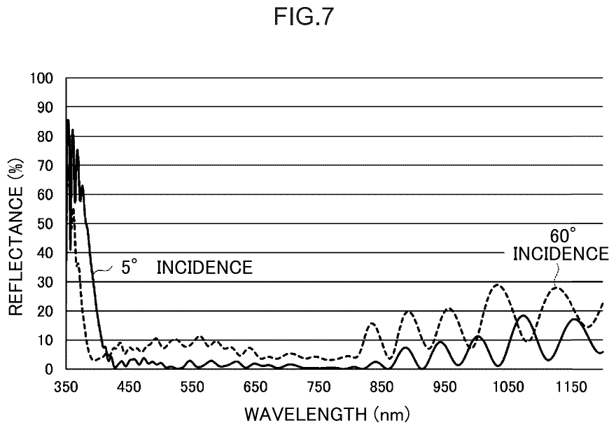

FIG. 7 provides one example of the reflectance profile obtained in the optical filter 1 for light incident from the first multilayer film side. In FIG. 7, the abscissa represents wavelength, and the ordinate represents reflectance. FIG. 7 provides the results obtained at both incidence angles θ=5° and θ=60°.

As shown in FIGS. 6 and 7, it is seen that, in the optical filter 1, the reflection of infrared rays was significantly inhibited in the infrared region despite the absence of infrared reflective film.

Table 12 below summarizes the parameters relating to the spectral characteristics measured for each optical filter.

TABLE 12

| | Optical filter | | | | | | | | | |
|---|---|---|---|---|---|---|---|---|---|---|
| Optical parameter | 1 | 2 | 3 | 4 | 5 | 6 | 7 | 8 | 9 | 10 |
| Average transmittance Tₜ₍ᵥ₎ₐᵥₑ₁ in wavelength range | 90.2 | 90.2 | 90 | 89.9 | 89.9 | 83.6 | 82.5 | 73.4 | 75.7 | 91.2 |
| of 440 nm to 500 nm at an incidence angle θ = 0° | | | | | | | | | | |
| Average transmittance Tₜ₍ᵥ₎ₐᵥₑ₂ in wavelength range | 83.5 | 83.5 | 83.3 | 82.8 | 83.3 | 76.1 | 75 | 65 | 67.6 | 88.6 |
| of 440 nm to 500 nm at an incidence angle θ = 60° | | | | | | | | | | |
| Wavelength λₜ₍ₜ₌₁₀₎₁ at which transmittance is 10% at | 677 | 677 | 677 | 677 | 675 | 681 | 680 | 674 | 676 | 680 |
| an incidence angle θ = 0° | | | | | | | | | | |
| Difference Δλₜ (absolute value) between wavelength | 9.0 | 10.0 | 11.0 | 11.0 | 11.0 | 11.0 | 11.0 | 12.0 | 11.0 | 9.0 |
| λₜ₍ₜ₌₁₀₎₂ at which transmittance is 10% at an | | | | | | | | | | |
| incidence angle θ = 60° and wavelength λₜ₍ₜ₌₁₀₎₁ | | | | | | | | | | |
| Average transmittance Tₜ₍ᵢ₎ₐᵥₑ₁ in wavelength range of | 0.4 | 0.4 | 0.4 | 0.4 | 0.4 | 3.69 | 3.12 | 1.48 | 1.64 | 4.55 |
| 750 nm to 1,000 nm at an incidence angle θ = 0° | | | | | | | | | | |
| Average transmittance Tₜ₍ᵢ₎ₐᵥₑ₂ in wavelength range of | 0.1 | 0.1 | 0.1 | 0.1 | 0.1 | 1.61 | 1.31 | 0.53 | 0.61 | 2.18 |
| 750 nm to 1,000 nm at an incidence angle θ = 60° | | | | | | | | | | |
| Maximum reflectance Rₜ₂ₘₐₓ₁ in wavelength range of | 5.2 | 5.2 | 5.2 | 5.5 | 9.4 | 5.27 | 5.3 | 5.26 | 5.16 | 4.88 |
| 450 nm to 950 nm at an incidence angle θ = 5°, | | | | | | | | | | |
| measured from second multilayer film side | | | | | | | | | | |
| Maximum reflectance Rₜ₂ₘₐₓ₂ in wavelength range of | 11.8 | 12.3 | 13.4 | 12.5 | 18.9 | 11.91 | 11.95 | 11.9 | 11.78 | 11.41 |
| 450 nm to 950 nm at an incidence angle θ = 60°, | | | | | | | | | | |
| measured from second multilayer film side | | | | | | | | | | |
| Maximum reflectance Rₜ₁ₘₐₓ₁ in wavelength range of | 9.2 | 15.4 | 21.2 | 25.1 | 27.1 | 9.36 | 9.39 | 9.35 | 9.22 | 8.83 |
| 450 nm to 950 nm at an incidence angle θ = 5°, | | | | | | | | | | |
| measured from first multilayer film side | | | | | | | | | | |
| Maximum reflectance Rₜ₁ₘₐₓ₂ in wavelength range of | 19.9 | 26.7 | 32.1 | 35.5 | 36.9 | 20.08 | 20.12 | 20.06 | 19.9 | 19.5 |
| 450 nm to 950 nm at an incidence angle θ = 60°, | | | | | | | | | | |
| measured from first multilayer film side | | | | | | | | | | |
| Absolute value of difference ΔTₜ₍ᵥ₎ₐᵥₑ between | 6.7 | 6.7 | 6.8 | 7.1 | 6.6 | 7.5 | 7.5 | 8.4 | 8.1 | 2.6 |
| average transmittance Tₜ₍ᵥ₎ₐᵥₑ₁ and average | | | | | | | | | | |
| transmittance Tₜ₍ᵥ₎ₐᵥₑ₂ | | | | | | | | | | |

As shown in Table 12, the optical filters 1 to 9 were confirmed to achieve sufficiently high transmittance in the visible light region. In addition, it was observed that the optical filters 1 to 9 sufficiently block light in the infrared region. Further, it was found that the optical characteristics of the optical filters 1 to 9 do not change significantly even when the incidence angle θ changes.

### (Aspects of Invention)

The invention encompasses the following aspects.

Aspect 1. An optical filter, comprising a glass substrate,
wherein
the glass substrate has a first main surface and a second main surface, which are opposite to each other,
on the first main surface of the glass substrate, a first barrier layer, a resin layer, and a first multilayer film are arranged in this order from the glass substrate,
on the second main surface of the glass substrate, a second barrier layer and a second multilayer film are arranged in this order from the glass substrate,
the glass substrate is a phosphate glass comprising an infrared absorber,
each of the first barrier layer and the second barrier layer independently comprises, in an amount of 80 mol % or more, an oxide of at least one metal selected from the group consisting of titanium (Ti), niobium (Nb), tantalum (Ta), and hafnium (Hf) in a ratio of 80 mol % or more,
the resin layer comprises a near-infrared absorbing dye having a maximum absorption wavelength in a range of from 700 nm to 800 nm, and
each of the first multilayer film and the second multilayer film is independently composed of plural dielectric layers.

Aspect 2. The optical filter according to Aspect 1, further comprising a third multilayer film composed of plural dielectric layers, the third multilayer film being provided between the first barrier layer and the resin layer,
wherein X, that is a value with respect to a portion composed of the first barrier layer and the third multilayer film and is represented by the following Formula (1), is 35% or more:

$$X ( \% ) = \{ A / ( B - C ) \} \times 100 \qquad ( 1 )$$

wherein A (nm) is a total thickness of dielectric layers, among the layers included in the portion, that satisfy both a QWOT of less than 2 and a refractive index of 1.9 or less, as determined by evaluating each layer included in the portion using QWOT represented by the following Formula (2):

$$QWOT = ( thickness of layer of interest / 550 nm ) \times 4 \times Refractive index at wavelength of 550 nm , \qquad ( 2 )$$

B (nm) is the total thickness of the portion, and
C (nm) is a total thickness of layers, among the layers included in the portion, that have a QWOT of 2 or more.

Aspect 3. The optical filter according to Aspect 1 or 2, having spectral characteristics that satisfy the following conditions (I) to (IV):
(I) at an incidence angle θ=0°, an average transmittance Tₜ₍ᵥ₎ₐᵥₑ₁ in a wavelength range of 440 nm to 500 nm is 70% or more, and at an incidence angle θ=60°, an average transmittance Tₜ₍ᵥ₎ₐᵥₑ₂ in the wavelength range of 440 nm to 500 nm is 65% or more;
(II) at an incidence angle θ=0°, a wavelength λₜ₍ₜ₌₁₀₎₁ at which the transmittance is 10% is in a range of 600 nm to 700 nm;
(III) at an incidence angle θ=60°, an absolute value of a difference Δλₜ between a wavelength λₜ₍ₜ₌₁₀₎₂ at which the transmittance is 10% and the wavelength λₜ₍ₜ₌₁₀₎₁ is 12 nm or less; and
(IV) at an incidence angle θ=0°, an average transmittance Tₜ₍ᵢ₎ₐᵥₑ₁ in a wavelength range of 750 nm to 1,000 nm is 4% or less, and at an incidence angle θ=60°, an average transmittance Tₜ₍ᵢ₎ₐᵥₑ₂ in the wavelength range of 750 nm to 1,000 nm is 4% or less.

Aspect 4. The optical filter according to any one of Aspects 1 to 3, having optical characteristics that satisfy the following conditions (V) and (VI) when light is incident from a side of the second multilayer film:
(V) at an incidence angle θ=5°, a maximum reflectance Rₜ₂ₘₐₓ₁ in a wavelength range of 450 nm to 950 nm is 10% or less; and
(VI) at an incidence angle θ=60°, a maximum reflectance Rₜ₂ₘₐₓ₂ in the wavelength range of 450 nm to 950 nm is 15% or less.

Aspect 5. The optical filter according to any one of Aspects 1 to 4, having optical characteristics that satisfy the following conditions (VII) and (VIII) when light is incident from a side of the first multilayer film:
(VII) at an incidence angle θ=5°, a maximum reflectance Rₜ₁ₘₐₓ₁ in a wavelength range of 450 nm to 950 nm is 35% or less; and
(VIII) at an incidence angle θ=60°, a maximum reflectance Rₜ₁ₘₐₓ₂ in the wavelength range of 450 nm to 950 nm is 35% or less.

Aspect 6. The optical filter according to Aspect 3, having optical characteristics (IX) in which an absolute value of a difference ΔTₜ₍ᵥ₎ₐᵥₑ between the average transmittance Tₜ₍ᵥ₎ₐᵥₑ₁ and the average transmittance Tₜ₍ᵥ₎ₐᵥₑ₂ is 10% or less.

Aspect 7. The optical filter according to any one of Aspects 1 to 6, wherein each of the first barrier layer and the second barrier layer is composed of an oxide of Ti.

Aspect 8. The optical filter according to any one of Aspects 1 to 7, wherein the optical comprises the third multilayer film as specified in Aspect 2, and the first barrier layer and the third multilayer film have a total thickness of 1.0 μm or more.

Aspect 9. The optical filter according to any one of Aspects 1 to 8, wherein the glass substrate has, in terms of oxide-based mass percentage, the following composition:
P₂O₅; from 40% to 75%,
Al₂O₃; from 10% to 30%,
CuO; from 2% to 30%,
a total amount of alkali metal components: from 0.10% to 30%, and
a total amount of alkaline earth metal components: from 0 to 30%,
and is substantially free of F.

Aspect 10. The optical filter according to any one of Aspect 1 to 9, wherein the glass substrate has spectral characteristics that satisfy the following conditions (i) to (iv) when converted to a thickness of 0.29 mm and at an incidence angle of 0°:
(i) an average transmittance T_{g(v)ave} in a wavelength range of 440 nm to 500 nm is 70% or more;
(ii) a transmittance T_{g(800)} at a wavelength of 800 nm is 7% or less;
(iii) a transmittance T_{g(1000)} at a wavelength of 1,000 nm is 7% or less; and
(iv) a transmittance T_{g(1200)} at a wavelength of 1,200 nm is 20% or less.

Aspect 11. An imaging device, comprising the optical filter according to any one of Aspects 1 to 10.

### DESCRIPTION OF SYMBOLS

100: First optical filter
110: Glass substrate
112: First main surface
114: Second main surface
120: First barrier layer
130: Second barrier layer
140: Resin layer
150: First multilayer film
160: Second multilayer film
200: Second optical filter
210: Glass substrate
212: First main surface
214: Second main surface
220: First barrier layer
230: Second barrier layer
240: Resin layer
250: First multilayer film
260: Second multilayer film
270: Third multilayer film
280: Laminated portion

What is claimed is:

1. An optical filter, comprising a glass substrate,
wherein
the glass substrate has a first main surface and a second main surface, which are opposite to each other,
on the first main surface of the glass substrate, a first barrier layer, a resin layer, and a first multilayer film are arranged in this order from the glass substrate,
on the second main surface of the glass substrate, a second barrier layer and a second multilayer film are arranged in this order from the glass substrate,
the glass substrate is a phosphate glass comprising an infrared absorber,
each of the first barrier layer and the second barrier layer independently comprises, in an amount of 80 mol % or more, an oxide of at least one metal selected from the group consisting of titanium (Ti), niobium (Nb), tantalum (Ta), and hafnium (Hf),
the resin layer comprises a near-infrared absorbing dye having a maximum absorption wavelength in a range of 700 nm to 800 nm, and
each of the first multilayer film and the second multilayer film is independently composed of plural dielectric layers.

2. The optical filter according to claim 1, further comprising a third multilayer film composed of plural dielectric layers, the third multilayer film being provided between the first barrier layer and the resin layer,
wherein X, that is a value with respect to a portion composed of the first barrier layer and the third multilayer film and is represented by the following Formula (1), is 35% or more:
$$X ( \% ) = \{ A / ( B - C ) \} \times 100 \qquad ( 1 )$$
wherein A (nm) is a total thickness of dielectric layers, among the layers included in the portion, that satisfy both a QWOT of less than 2 and a refractive index of 1.9 or less, as determined by evaluating each layer included in the portion using QWOT represented by the following Formula (2):
$$QWOT = ( thickness of layer of interest / 550 nm ) \times 4 \times Refractive index at wavelength of 550 nm , \qquad ( 2 )$$
B (nm) is the total thickness of the portion, and
C (nm) is a total thickness of layers, among the layers included in the portion, that have a QWOT of 2 or more.

3. The optical filter according to claim 1, having spectral characteristics that satisfy the following conditions (I) to (IV):
(I) at an incidence angle θ=0°, an average transmittance Tₜ₍ᵥ₎ₐᵥₑ₁ in a wavelength range of 440 nm to 500 nm is 70% or more, and at an incidence angle θ=60°, an average transmittance Tₜ₍ᵥ₎ₐᵥₑ₂ in the wavelength range of 440 nm to 500 nm is 65% or more;
(II) at an incidence angle θ=0°, a wavelength λₜ₍ₜ₌₁₀₎₁ at which the transmittance is 10% is in a range of 600 nm to 700 nm;
(III) at an incidence angle θ=60°, an absolute value of a difference Δλₜ between a wavelength λₜ₍ₜ₌₁₀₎₂ at which the transmittance is 10% and the wavelength λₜ₍ₜ₌₁₀₎₁ is 12 nm or less; and
(IV) at an incidence angle θ=0°, an average transmittance Tₜ₍ᵢ₎ₐᵥₑ₁ in a wavelength range of 750 nm to 1,000 nm is 4% or less, and at an incidence angle θ=60°, an average transmittance Tₜ₍ᵢ₎ₐᵥₑ₂ in the wavelength range of 750 nm to 1,000 nm is 4% or less.

4. The optical filter according to claim 1, having optical characteristics that satisfy the following conditions (V) and (VI) when light is incident from a side of the second multilayer film:
(V) at an incidence angle θ=5°, a maximum reflectance Rₜ₂ₘₐₓ₁ in a wavelength range of 450 nm to 950 nm is 10% or less; and
(VI) at an incidence angle θ=60°, a maximum reflectance Rₜ₂ₘₐₓ₂ in the wavelength range of 450 nm to 950 nm is 15% or less.

5. The optical filter according to claim 1, having optical characteristics that satisfy the following conditions (VII) and (VIII) when light is incident from a side of the first multilayer film:
(VII) at an incidence angle θ=5°, a maximum reflectance Rₜ₁ₘₐₓ₁ in a wavelength range of 450 nm to 950 nm is 35% or less; and
(VIII) at an incidence angle θ=60°, a maximum reflectance Rₜ₁ₘₐₓ₂ in the wavelength range of 450 nm to 950 nm is 35% or less.

6. The optical filter according to claim 3, having optical characteristics (IX) in which an absolute value of a difference ΔTₜ₍ᵥ₎ₐᵥₑ between the average transmittance Tₜ₍ᵥ₎ₐᵥₑ₁ and the average transmittance Tₜ₍ᵥ₎ₐᵥₑ₂ is 10% or less.

7. The optical filter according to claim 1, wherein each of the first barrier layer and the second barrier layer is composed of an oxide of Ti.

8. The optical filter according to claim 2, wherein the first barrier layer and the third multilayer film have a total thickness of 1.0 μm or more.

9. The optical filter according to claim 1, wherein the glass substrate has, in terms of oxide-based mass percentage, the following composition:
P₂O₅; from 40% to 75%,
Al₂O₃; from 10% to 30%,
CuO; from 2% to 30%,
a total amount of alkali metal components: from 0.1% to 30%, and
a total amount of alkaline earth metal components: from 0 to 30%,
and is substantially free of F.

10. The optical filter according to claim 1, wherein the glass substrate has spectral characteristics that satisfy the following conditions (i) to (iv) when converted to a thickness of 0.29 mm and at an incidence angle of 0°:
(i) an average transmittance T_{g(v)ave} in a wavelength range of 440 nm to 500 nm is 70% or more;
(ii) a transmittance T_{g(800)} at a wavelength of 800 nm is 7% or less;
(iii) a transmittance T_{g(1000)} at a wavelength of 1,000 nm is 7% or less; and
(iv) a transmittance T_{g(1200)} at a wavelength of 1,200 nm is 20% or less.

11. An imaging device, comprising the optical filter according to claim 1.
